(19) United States
(12) Patent Application Publication
(10) Pub. No.: US 2026/0220418 A1
(43) Pub. Date: Jul. 30, 2026

(54) ULTRA-HIGH FREQUENCY ANTENNA DEVICE, ULTRA-HIGH FREQUENCY ANTENNA ASSEMBLY, DEVICE METHOD OF FORMING SUCH AN ANTENNA DEVICE, AND SUPPORT BODY MATERIAL SUPPLY

(71) Applicant: LINXENS HOLDING, Mantes la Jolie (FR)

(72) Inventor: Lars KLEMM, Dresden (DE)

(21) Appl. No.: 19/145,674

(22) PCT Filed: Jan. 4, 2023
(86) PCT No.: PCT/IB2023/000004

§ 371 Date: Jul. 3, 2025

(51) Int. Cl. G06K 19/077

(52) U.S. Cl. CPC G06K 19/07792; G06K 19/07718; G06K 19/07786

(57) ABSTRACT

The present disclosure provides in various aspects an ultra-high frequency (UHF) antenna device, ultra-high frequency (UHF) antenna assembly, a method of forming an ultra-high frequency (UHF) antenna device, and a support body material supply. In a first aspect of the present disclosure, an ultra-high frequency (UHF) antenna device is provided, the UHF antenna device comprising a radio frequency identification (RFID) chip, and an antenna support body with an antenna-wiring pattern formed on a surface of the antenna support body, and an UHF antenna loop electrically coupled with the RFID chip. The UHF antenna loop is configured to emit and/or receive a frequency range in the UHF band and comprises a first loop portion formed of the antenna-wiring pattern and a second loop portion extending at least partially outside of the antenna support body.

### RELATED APPLICATION

This application claims priority to International Application No. PCTIB2023/000004, filed Jan. 4, 2023, the contents of which are incorporated by reference herein in its entirety.

### FIELD OF INVENTION

The present invention relates to an ultra-high frequency (UHF) antenna device, ultra-high frequency (UHF) antenna assembly, a method of forming an ultra-high frequency (UHF) antenna device, and a support body material supply.

### BACKGROUND AND RELATED ART

In recent years, radio frequency identification (RFID) technology has increasingly moved into everyday life. In particular, RFID technology is employed in many products, processes, tools and/or equipment for assisting in manufacturing processes, the handling of manufactured goods and manufacturing materials in a variety of manufacturing processes. RFID technology enables identification from a distance, and unlike earlier bar-code technology, it does so without requiring a line of sight.

Today, many types of RFID devices exist, which are basically associated with one of the following two classes: active RFID devices and passive RFID devices. Active RFID devices require a power source, while passive RFID devices do not require a power source and draw the energy needed for its operation from the electromagnetic field applied to the RFID device for accessing its information. Therefore, passive RFID devices can be provided at low cost, low size and a greater lifetime when compared to active RFID devices such that the range of application of passive RFID devices is very broad and reaches into almost every field of technical applications. Typically, such applications relate to labelling of goods, identification of animals, making toys interactive, preventing theft, locating lost items and the like.

Usually, passive RFID devices are provided in form of tags of variable sizes down to very small dimensions, which are even small enough to fit into devices of sizes in the centimeter range. A passive RFID tag generally consists of an antenna, a semiconductor chip attached to the antenna, and optionally some form of encapsulation for protecting the antenna and the chip from environmental conditions or reagents.

In small tag application, an antenna of the tags needs to be responsive to high frequencies such that RFID devices with antennas in the dimension of centimeters needs a frequency in the ultra-high frequency (UHF) band in the range from about 300 MHz to 3 GHz. Antennas which are employed for receiving and/or emitting UHF frequencies of the UHF band allow for point-to-point communication. In using such antennas, it is possible to track an UHF tag over comparatively large distances in the far field, e.g., distances up to 10 meters.

With an increasing automation, there is an increasing need for individual traceability of various items, objects, and goods during manufacturing processes, transportation processes and/or storage processes.

There is an increasing need for individual traceability of containers, such as but not limited to, containers for medical devices, with a traceability extending from the manufacturing process of the containers until final labeling, final use, and/or disposal of the containers. In the example of containers for medical devices, caps of syringe bodies are equipped with an RFID tag in order to allow for a traceability of syringe bodies. However, the labelling of the caps of syringe bodies pose various challenges on the preparation and integration of RFID tags into the caps. On the one hand, the small geometric sizes of conventional caps of syringe bodies and the designs of such caps limit the available surface of an antenna loop of the RFID tag to a surface of the cap, thereby constraining antenna loop geometries in such RFID tags and limiting a read range of the RFID tag. On the other hand, it is important for RFID tags of medical containers to be resistant against the influence of disinfectants used in medical environments.

When equipping small objects with RFID tags, such as but not limited to, the medical containers described above, specific challenges may arise in complying with adhesion requirements, in particular the RFID tag shall adhere reliably to the object, within a strongly constrained space due to small available volume and surface of the object to be labelled with the RFID tag. For example, when attempting to mold RFID tags into objects, issues occur in that holding (vacuum/IML electrostatic pre charge) the RFID tag in an injection molding (so-called “in-mold”) cavity of a molding tool becomes very challenging. A reliable molding of the RFID tag into an object is prone to damage due to an incompatibility of mold material and substrate material of an RFID tag carrying the antenna loop, such as a delamination of the RFID tag from a surface of the object if the RFID tag is molded to a surface caused by this incompatibility. Further manufacturing techniques provide two plastic parts and a sealing plus inlaying tag, however, they result in higher manufacturing costs due to more process steps and the resulting device would not meet the thickness requirements for a medical container, such as for example a needle cap.

Document WO 2022/094382 A1 shows tip cap assembly for coupling with a syringe body, wherein an RFID tag is positioned over a distal end of the tip cap.

In view of the above, discussion of the related art, it is desirable to provide an UHF antenna device and a method of forming such an antenna device, which overcomes issues and drawbacks of known devices.

### SUMMARY

The above and other objects are at least partially overcome in various aspects of the present disclosure by an ultra-high frequency (UHF) antenna device, ultra-high frequency (UHF) antenna assembly, a method of forming an ultra-high frequency (UHF) antenna device, and a support body material supply.

In a first aspect of the present disclosure, an ultra-high frequency (UHF) antenna device is provided. In the illustrative embodiments of the first aspect, the UHF antenna device comprises a radio frequency identification (RFID) chip, and an antenna support body with an antenna-wiring pattern formed on a surface of the antenna support body, and an UHF antenna loop electrically coupled with the RFID chip. The UHF antenna loop is configured to emit and/or receive a frequency range in the UHF band and comprises a first loop portion formed of the antenna-wiring pattern and a second loop portion extending at least partially outside of the antenna support body. The antenna-wiring pattern does not provide a completely functional UHF antenna loop. In particular, the antenna-wiring pattern is complemented by the second loop portion to provide the completely functional UHF antenna loop only in combination with the second loop portion such that the UHF antenna loop implements a particular resonance frequency as desired for a specific application of the UHF antenna device.

According to the first aspect, the UHF antenna loop is not confined to a surface of the antenna support body and therefore allows a reading of the UHF antenna device substantially along a direction that is not normal to a surface of the antenna support body. Furthermore, upon decoupling the UHF antenna loop from a surface of the antenna support body, a greater flexibility in the application of the antenna support body to an assembly to be equipped with the UHF antenna device is possible. In particular, size and/or shape of the antenna support body may be decoupled from a specific application of the antenna support body (e.g., a specific shape as required by the specific application) as the UHF antenna loop is not exclusively confined to size and shape of the antenna support body. Accordingly, a tuning of the resonance frequency of the UHF antenna loop may be achieved on the basis of the second loop portion independently from the first loop portion.

In the illustrative embodiments of the present disclosure, the UHF band is identified with the frequency band ranging from about 300 MHz to about 3 GHz. A frequency range which may be emitted and/or received by the UHF antenna loop, is understood as representing a frequency range which at least partially overlaps with the UHF band.

In some illustrative embodiments of the first aspect, the antenna support body may be formed of a support body of slotted shape, e.g., a cylindrical shape such as a hollow cylindrical shape obtained by bending and/or rolling the support body into a slotted shape. The slotted shape has an outer lateral surface and an inner surface radially opposite to the outer lateral surface, the outer lateral surface and inner surface being discontinued at a slit, which axially extends along the support body. The antenna-wiring pattern may comprise at least two contact pads formed in the inner surface and separated by a gap extending over a gap region between the two contact pads. Furthermore, a bridging portion may be formed on the inner surface for electrically such that at least two of the at least two contact pads on the support body are coupled along a first circumferential region along the inner surface, wherein the bridging portion is electrically coupled with the RFID chip. In illustrative examples, the antenna support body may represent a slotted sleeve or hollow cylindrical body where the antenna-wiring pattern is formed on a surface, e.g., the inner surface, of the support body. The provision of the antenna support body in form of the support body of slotted hollow cylindrical shape allows providing an UHF antenna device in applications where a cylindrical item is to be labelled with the UHF antenna device. Furthermore, the provision of at least two contact pads coupled by the RFID chip allows a simple but efficient contacting between the antenna wiring pattern and the second loop portion. In some illustrative examples herein, the RFID chip may be located within the first circumferential region such that a compact antenna support body integrated with the RFID chip may be provided. In some other illustrative examples herein, the second loop portion may comprise a slotted ring in electrical connection with the at least two contact pads which are in electrical connection with the RFID chip such that a self-sustaining second loop portion is realized by the slotted ring, thereby allowing reading of the antenna device along a direction of the slotted ring which is normal to the plane into which the ring is embedded (i.e., a virtual plane into which the ring may be embedded or which may be approximated to comprise the ring in a best fit scheme, e.g., least square). A slotted ring represents an elastic deformable element, which, due to its slotted configuration, allows for an elastic reduction of a diameter of the slotted ring.

The term “cylindrical” is to be understood as denoting a shape that corresponds to a cylinder or to a shape that may be obtained by elastically or inelastically deforming a cylinder, e.g., by squeezing and/or bending and/or rolling and/or stretching and/or shearing and/or a combination thereof, such that at least one corner or rounded corner is present. A cross-sectional shape of a cylindrical body may be, for example, of a polygonal shape with one or more rounded corners.

The term “ring” is to be understood as denoting a shape that corresponds to a ring or to a shape that may be obtained by elastically or inelastically deforming a ring, e.g., by squeezing and/or bending and/or rolling and/or stretching and/or shearing and/or a combination thereof, such that at least one corner or rounded corner is present. A cross-sectional shape of a ring body and/or its top view may be, for example, of a polygonal shape with one or more rounded corners.

In some special illustrative examples, the slotted ring may have a diameter in the range from about 1 mm to about 50 mm, exemplifying a very compact antenna device. Additionally, or alternatively, the slotted ring may have a flat, round, or quadrangular cross-sectional shape as an illustrative but non-limiting example of a slotted ring configuration. Generally, the slotted ring may be embodied in shape and dimension such that the second loop portion is adapted to any desired technical application, the second loop portion being configurable independently from the first loop portion of the antenna loop as long as the first and second loop portions may be coupled with the UHF antenna loop.

In special illustrative examples of the slotted ring, the slotted ring may have a slit formed therein, the slit axially extending along the inner surface in a second circumferential region. The first circumferential region and the second circumferential region may be arranged so as to at least partially overlap and/or the gap region and the second circumferential region may be arranged so as to at least partially overlap. Accordingly, any interference between the ring and the RFID chip and/or the contact pads and the ring may be avoided.

In some other illustrative embodiments of the first aspect, the antenna support body may be formed of a support sheet rolled into a cylindrical or semi cylindrical shape. Upon selecting the antenna support body in form of a support sheet, a very thin and flexible antenna support body may be provided which may be adapted to any desired shape of the second loop portions and or to a surface of an item to be labelled with the UHF antenna device. An according antenna support body may be embodied in a desired non-planar, e.g., curved, surface modelling a surface region which is to be labelled by the UHF antenna device.

In some illustrative embodiments of the first aspect, the antenna support body may be formed of a thermoplastic material. In accordance with examples herein, the antenna support body may be formed of polyolefin such as polypropylene (PP), polyethylene (PE) and the like. Upon appropriately selecting the material of the antenna support body, the antenna support body may be provided in compliance with the material of an item to be labelled with the UHF antenna device. For example, when applying the UHF antenna device for labelling an in-mold product, a material of the antenna support body may be chosen to be equal to or match best the material of the in-mold product. Accordingly, the antenna support body may be integrated into the in-mold process without deteriorating the integrity of the mold product. For example, when using a similar or equal material to the in-mold material used in in-molding the antenna device, formation of bubbles and/or the flaking off of the antenna support body of an item to be labelled is avoided.

In accordance with some illustrative embodiments of the first aspect, the antenna-wiring pattern may be formed of a conductive material, e.g., silver or another conductive material, deposited on the antenna support body, or the antenna wiring pattern may comprise one or more strip layer elements with a strip layer thickness in the range of about 1 μm to about 1000 μm's. For example, a silver material may be advantageously deposited on antenna support bodies formed of a thermal plastic material because of optimum adhesion of the silver material on thermal plastic material when compared to copper or aluminum. However, the formation of the antenna wiring pattern from silver is not intended to limit the present disclosure to this material and the use of a conductive material other than silver may be considered instead, e.g., gold and/or copper and/or aluminum and an alloy thereof.

In a second aspect of the present disclosure, an ultra-high frequency (UHF) antenna assembly is provided. In the illustrative embodiments of the second aspect, the UHF antenna assembly comprises an UHF antenna device of the first aspect and an assembly body. The UHF antenna device is integrated into the assembly body.

In some illustrative embodiments of the second aspect, the assembly body may be a sleeve body or comprise a sleeve body portion. In some other illustrative embodiments, the antenna support body may be molded into the assembly body such that UHF antenna device is at least partially embedded into assembly body. For example, the UHF antenna loop may be at least partially embedded into the assembly body. Accordingly, the UHF antenna loop may be protected against environmental effects in a simple manner.

In some illustrative examples herein, an outer lateral surface of the support body may be exposed in an outer surface region of the assembly body such that the antenna-wiring pattern may be protected against environmental effects. An outer lateral surface of the antenna support body may be understood as representing a surface of the antenna support body opposite the surface of the antenna support body on which the antenna-wiring pattern is formed.

In a third aspect of the present disclosure, a method of forming an ultra-high frequency (UHF) antenna device is provided. In the illustrative embodiments of the third aspect, the method comprises providing a support body material supply for feeding support body material, forming a repetitive pattern of an antenna-wiring loop on the surface of the support body material supplied by the support body material supply, wherein the support body material has a plurality of antenna field regions each of which being provided with an antenna-wiring loop, removing at least one of the plurality of antenna field regions formed on the surface of the support body material from the support body material supply, preparing an antenna support body on the basis of at least one antenna field region, wherein the partial antenna wiring loop defining a first loop portion has an antenna-wiring pattern formed in each removed antenna field region, and complementing the partial antenna-wiring loop into a complete UHF antenna loop by electrically coupling a second loop portion to the first loop portion. The second loop portion extends at least partially outside the antenna support body. Herein, the partial antenna-wiring loop is obtained during or after removing the at least one antenna field region from the support body material supply when a wiring loop portion of the antenna-wiring loop is removed.

The second loop portion extending at least partially outside the antenna support body is to be understood as indicating that the second loop portion is substantially not formed by the antenna-wiring pattern, but represents a separate element that is electrically coupled with the antenna-wiring pattern. Neither one of the first loop portion and the second loop portion as such provide a functional antenna loop, only the combination of the first loop portion and the second loop portion provides a functional antenna loop. Furthermore, the second loop portion extending outside of the antenna support body is understood such that a part of the second loop portion extends, with respect to the antenna support body, in a manner such that this part of the second loop portion is not in direct mechanical contact with the antenna support body. Herein, a direct mechanical contact of the part of the second loop portion with the antenna support body means that the specific part of the second loop portion is not in direct mechanical contact with the antenna support body or the antenna-wiring portion. Instead, at least one dielectric material extends between this part of the second loop portion and the antenna support body.

In some illustrative embodiments of the third aspect, the antenna-wiring loop in each antenna field region may comprise at least two contact pads. Furthermore, forming the repetitive pattern may comprise electrically coupling the antenna-wiring loop of at least one antenna field region with a radio frequency identification (RFID) chip prior to removing the wiring loop portion. Accordingly, a reliable contacting of the antenna-wiring loop with the second loop portion is possible and a functional UHF antenna-wiring loop may be prepared by coupling an RFID chip with the antenna-wiring loop at an early stage during fabrication of the UHF antenna device. This allows testing the antenna-wiring loop during the early stages of the fabrication process. In illustrative examples herein, preparing the antenna support body may comprise rolling the removed at least one antenna field region into a cylindrical or semi-cylindrical shape. Accordingly, the antenna support body may be easily obtained. In some other illustrative examples herein, the method may further comprise performing a test on at least one antenna field region coupled with the RFID chip by exposing the at least one antenna field region coupled with the RFID chip to a UHF reader device. Accordingly, the testing is performed early during fabrication.

In some illustrative embodiments of the second aspect, forming the repetitive pattern of the antenna-wiring loop may comprise depositing a conductive material layer, e.g., a silver material layer, on the surface of the support body material by screen-printing the conductive material layer on the surface of the support body material. Accordingly, the repetitive pattern of the antenna-wiring loop may be easily achieved and reproduced in mass production. In special illustrative examples herein, the conductive material may be silver material and the conductive material layer may be a silver material layer, silver being advantageously formable on a surface of thermoplastic material, e.g., PE, PET or PP. However, the formation of the antenna wiring pattern from silver is not intended to limit the present disclosure to this material and the use of a conductive material other than silver may be considered instead, e.g., gold and/or copper and/or aluminum and an alloy thereof.

In some other illustrative embodiments of the second aspect, forming the repetitive pattern of the antenna-wiring loop may alternatively comprise depositing a conductive material layer, e.g., a silver material layer, on the surface of the support body material and patterning the deposited conductive material layer by applying an etching process. Accordingly, the repetitive pattern may be provided in alternative but simple fabrication processes suitable for mass production. In special illustrative examples herein, the conductive material may be silver material and the conductive material layer may be a silver material layer, silver being advantageously formable on a surface of thermoplastic material, e.g., PE, PET or PP. However, the formation of the antenna wiring pattern from silver is not intended to limit the present disclosure to this material and the use of a conductive material other than silver may be considered instead, e.g., gold and/or copper and/or aluminum and an alloy thereof.

In accordance with some illustrative embodiments of the third aspect, removing at least one of the pluralities of the antenna field regions may comprise applying one or more punching processes for separating at least one of the antenna field regions from the support body material supply. Accordingly, individual removed antenna field regions may be easily provided.

In accordance with some illustrative embodiments of the third aspect, complementing the partial antenna-wiring loop into a complete UHF antenna loop may comprise inserting a separated antenna field region into a mold cavity of a mold tool such that the partial antenna-wiring loop is exposed to the interior of the mold cavity, inserting a slotted ring into the mold cavity such that the slotted ring is brought into mechanical contact with the partial antenna-wiring loop so as to complete the partial antenna-wiring loop into a complete UHF antenna loop, wherein a slit of the slotted ring is arranged in contact with the antenna field region and injecting molding material into the cavity of the mold tool. This is a special illustrative example of an advantageous molding process. However, without limitation, inserting the slotted ring into the mold cavity may be replaced by arranging the second loop portion, e.g. a wire portion or strip or the like, on the partial antenna-wiring loop so as to complete the partial antenna wiring loop into the complete UHF antenna loop. The completed UHF antenna loop may be formed such that contacts of the second loop portion electrically contact the partial antenna-wiring loop. Accordingly, an in-molded UHF antenna loop, at least partially embedded into the molding material, may be achieved.

In a fourth aspect of the present disclosure, a method of fabricating an ultra-high frequency (UHF) antenna device is provided. In the illustrative embodiments of the fourth aspect, the method comprises providing a support body material supply for feeding support body material forming a repetitive pattern of at least two contact pads on a plurality of antenna field regions of the support body material, each antenna field region of the plurality of antenna field regions comprising the repetitive pattern of at least two contact pads, forming a bridging portion in each antenna field region for electrically coupling two of the at least two contact pads, the bridging portion comprising a RFID chip electrically coupling at least two of the at least two contact pads with each other, and forming a repetitive test structure pattern with at least one test check on the support body material for supplementing the at least two contact pads coupled with the RFID chip into a UHF loop structure in each antenna field region. Accordingly, an antenna device, which is testable through an early stage during fabrication, may be provided where the UHF loop structure represents a testable UHF testing loop at the early stages during fabrication.

In some illustrative examples herein, forming the repetitive pattern of at least two contact pads and/or forming the repetitive test structure pattern comprises depositing a conductive material layer on the surface of the support body material and patterning the deposited conductive material layer by applying an etching process. Alternatively, a conductive material layer may be deposited on the surface of the support body material by screen printing conductive material onto the surface of the support body material. In special illustrative examples herein, the conductive material may be silver material and the conductive material layer may be a silver material layer, silver being advantageously formable on a surface of thermoplastic material, e.g., PE, PET or PP. However, the formation of the antenna wiring pattern from silver is not intended to limit the present disclosure to this material and the use of a conductive material other than silver may be considered instead, e.g., gold and/or copper and/or aluminum and an alloy thereof.

In some illustrative embodiments of the fourth aspect, the method may further comprise applying one or more punching processes for separating the antenna field regions from the support body material supply and removing the test structure pattern in each antenna field region. In some special illustrative examples herein, the method may further comprise repairing an antenna support body by rolling the removed at least one antenna field region into a cylindrical or semi-cylindrical shape.

In some illustrative embodiments of the fourth aspect, the method may further comprise inserting separated antenna field regions into each mold cavity of a mold tool such that the contact pads of each antenna field region are exposed to the interior of the respective mold cavity of the mold tool, inserting a slotting ring into each mold cavity of the mold tool equipped with a respective separated antenna field region such that the slotted ring, in their respective mold cavity, is brought into mechanical contact with the at least two of the at least two contact pads coupled by the bridging portion, a slit of the slotted ring being arranged at the bridging portion of the respective mold cavity and injecting molding material into each cavity of the mold tool.

In some illustrative embodiments of the third aspect and/or fourth aspect, the support body material supply may comprise a reel of support body material wound on the reel and providing the support body material supply may comprise a reel-to-reel feeding of the support body material.

In some illustrative embodiments of the third aspect and/or fourth aspect, the support body material may be a thermoplastic material.

In some illustrative embodiments of the third aspect and/or fourth aspect, the UHF antenna device of the first aspect may be formed in the fabrication process and/or the UHF antenna assembly of the second aspect may be formed in the fabrication process.

In a fifth aspect of the present disclosure a support body material supply is provided. In the illustrative embodiments herein, the support body material supply comprises a reel of support body material wound on the reel, a repetitive pattern of an antenna wiring loop formed on the surface of the support body material supplied by the support body material supply wherein the support body material has a plurality of antenna field regions each of which is provided with an antenna wiring loop and a plurality of RFID chips, each of which being electrically coupled with the antenna wiring loop of each antenna field region.

In some illustrative embodiments of the fifth aspect, the repetitive pattern of the antenna wiring loop may comprise at least two contact pads in each antenna field region, a bridging portion within each antenna field region electrically coupling at least two of the at least two contact pads in each antenna field region, wherein the bridging portion within each antenna field region comprises the RFID chip.

In some illustrative embodiments of the fifth aspect, the support body material may be a thermoplastic material.

In some illustrative embodiments of the fifth aspect, the repetitive pattern of the antenna-wiring loop may comprise a conductive material, e.g., a silver material or another conductive material, formed on the surface of the support body material.

In some illustrative embodiments of the fifth aspect, the support body material supply may be formed in the method of the third and/or fourth aspect.

### BRIEF DESCRIPTION OF THE DRAWINGS

Various illustrative embodiments and other advantages of the various aspects of the present disclosure will become apparent from the detailed description of the accompanying figures as presented below.

FIG. 1 schematically shows, in a perspective view, an antenna device in accordance with some illustrative embodiments of the present disclosure.

FIG. 2 schematically shows, in a perspective view, another antenna device in accordance with other illustrative embodiments of the present disclosure.

FIGS. 3a to 3c show, in perspective views, a second loop portion in accordance with some illustrative embodiments of the present disclosure.

FIG. 4 schematically shows an initial stage during fabrication of support body materials applied in accordance with some illustrative embodiments of the present disclosure.

FIG. 5 schematically shows a support body material supply, in accordance with some illustrative embodiments, during further processing in accordance with some illustrative embodiments of the present disclosure.

FIG. 6 schematically shows an antenna field region in accordance some illustrative embodiments of the present disclosure.

FIG. 7 schematically shows an antenna field region in accordance some other illustrative embodiments of the present disclosure.

FIGS. 8a to 8c schematically show a process for fabricating an antenna device in accordance some other illustrative embodiments of the present disclosure.

The figures accompanying the present disclosure are only provided for schematically showing some concepts and aspects of the present disclosure without showing all possible details of certain embodiments and without necessarily being to scale.

### DETAILED DESCRIPTION

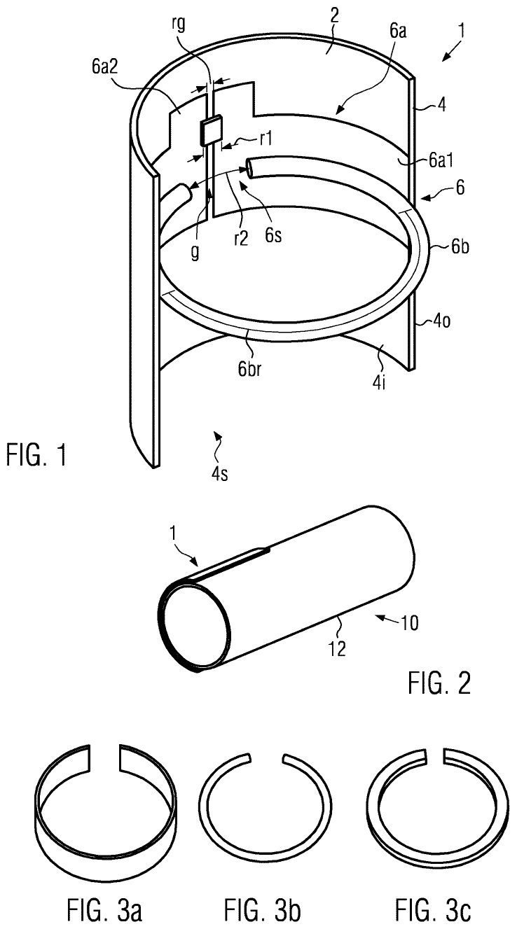

, such as a PET substrate. Alternatively, the antenna support body 4 With regard to FIGS. 1 to 3, various illustrative embodiments of an ultra-high frequency (UHF) antenna device will be described.

In the illustrative embodiments described below, the UHF antenna device is configured to emit and/or receive a frequency range. The frequency range comprise frequencies of an UHF band, wherein the UHF band is identified with the frequency band ranging from about 300 MHz to about 3 GHZ. In particular, the frequency range, which may be emitted and/or received by the UHF antenna loop, may be understood as representing a frequency range that at least partially overlaps with the UHF band.

Referring to FIG. 1, an ultra-high frequency (UHF) antenna device 1 is schematically illustrated in a perspective view in accordance with some illustrative embodiments of the present disclosure. The UHF antenna device 1 comprises a RFID chip 2, an antenna support body 4, and an UHF antenna loop 6 electrically coupling to the RFID chip 2.

In accordance with some illustrative embodiments of the present disclosure, the antenna support body 4 may be formed of a flexible substrate, such as a flexible printed circuit board substrate may be a rigid or a self-supporting material body, such as a molded body formed in a desired shape. Still alternatively, the antenna support body 4 may be provided by a rigid or flexible printed circuit board substrate.

In some special illustrative but not limiting examples, the antenna support body 4 may be formed of a thermoplastic material, such as polyolefin materials. In some special illustrate examples herein, the antenna support body 4 may be provided as a support sheet formed of a foil of thermoplastic material, such as a foil of polyolefin material.

As illustrated in FIG. 1, the UHF antenna loop 6, comprises a first loop portion which comprises an antenna-wiring pattern 6a formed on a surface 4i of the antenna support body. For example, the antenna-wiring pattern 6a comprises at least two contact pads such as the illustrated contact pads 6a1 and 6a2. Although FIG. 1 only shows the two contact pads 6a1 and 6a2, this does not pose any limitation on the present disclosure and a number of more than two contact pads may be formed on the surface 4i of the antenna support body 4 instead.

In some illustrative but non-limiting examples, the contact pads 6a1 and 6a2 (providing the illustrated antenna-wiring pattern 6a) formed on the surface 4i of the antenna support body 4 are formed in an L-shape. However, this shape of the contact pads 6a1 and 6a2 is not limiting to the present disclosure and any desired and appropriate shape of the contact pads 6a1 and 6a2 may be implemented instead, such as a T-shape, a C-shape, a disk shape, a polygonal shape, an oval shape and so on.

With ongoing reference to FIG. 1, the UHF antenna loop 6 further comprises a second loop portion 6b extending partially outside of the antenna support body 4. The second loop portion 6b represents an element of the UHF antenna loop 6, which is not formed as part of the antenna-wiring pattern 6a on the surface 4i of the antenna support body 4. The second loop portion 6b has an integral part thereof that is not in direct mechanical contact with the antenna support body 4 and the antenna-wiring pattern 6a. For example, as shown in FIG. 1, the second loop portion 6b has a ring-shaped part 6br (representing an integral part of the second loop portion 6b) extending without direct mechanical contact to the surface 4i of the antenna support body 4 and the antenna-wiring pattern 6a. In other words, the second loop portion 6b represents an element of the UHF antenna loop 6 that is separate from the antenna-wiring pattern 6a and extends out of the surface 4i of the antenna support body 4 on which the antenna-wiring pattern 6a is formed. Accordingly, the second loop portion 6 allows adjustment of a dimension of the UHF antenna loop 6 without limitation to the explicit dimensions of the antenna support body 4.

Referring to the illustrative example shown in FIG. 1, the second loop portion 6b is implemented as a slotted ring having a slit 6s that extends over a circumferential region r2 along the circumference of the slotted ring 6b. The antenna-wiring pattern 6a has the contact pads 6a1 and 6a2 arranged on the surface 4i of the antenna support body 4 such that the two contact pads 6a1 and 6a2 are not in direct contact with each other but separated by a gap g on the surface 4i of the antenna support body 4, the gap g extending over a gap region rg between the two contact pads 6a1 and 6a2.

With ongoing reference to FIG. 1, the two contact pads 6a1 and 6a2 are electrically coupled by a bridging portion over the gap g, the bridging portion comprising the RFID chip 2 which, in the illustration of FIG. 1 forms the bridging portion. However, this does not pose any limitation on the present disclosure and the person skilled in the art will appreciate that the bridging portion may comprise conductive lines (not illustrated) extending between the RFID chip 2 and at least one of the contact pads 6a1 and 6a2. Accordingly, a direct arrangement of the RFID chip 2 on the contact pads or in direct proximity to the contact pads 6a1 and 6a2 may be avoided. In some alternative embodiments (not illustrated) the RFID chip 2 may be provided separate from the contact pad 6a1 and 6a2 on the surface 4i or the RFID chip 2 may even be provided on a surface 40 opposite the surface 4i of the antenna support body 4. In the illustration of FIG. 1, the RFID chip 2 represents a bridging portion extending along a circumferential region as indicated by reference numeral r1 in FIG. 1.

In accordance with illustrative embodiments, the circumferential region r2 at least partially overlaps with at least one of the gap regions rg and the circumferential region r1 such that the second loop portion 6b does not interfere with at least one of the bridging portion 2 and antenna-wiring pattern 6a.

In some illustrative examples herein, the RFID chip 2 may be located in direct mechanical contact with the contact pad 6a1 and 6a2 outside the circumferential region r2. Furthermore, only the gap g separating the contact pad 6a1 and 6a2 in the surface 4i of the antenna support body 4 may be within the circumferential region r2. Accordingly, the circumferential region r2 and the gap region rg at least partially overlap, i.e., completely overlap as shown in FIG. 1.

In some illustrative but non-illustrated embodiments, the RFID chip 2 may define a circumferential region greater than r1 illustrated in FIG. 1, without interfering with the slit 6s of the ring 6b due to the L-shaped contact pads 6a1 and 6a2, i.e., bridging over the gap g at a surface region of the antenna wiring pattern 6a outside of the slit 6s. The RFID chip 2 may be arranged at the circumferential region r2 within the slit 6s without interfering with the ring 6b.

With ongoing reference to FIG. 1, the antenna-wiring pattern 6a may be provided by a conductive material deposited on the surface 4i or a conductive material attached to the surface 4i of the antenna support body 4, e.g. by adhesion, bonding or welding. Alternatively, the antenna-wiring pattern 6a may be formed by blanket deposition of a conductive material on the surface 4i of the antenna support body 4 and subsequently etching the antenna-wiring pattern 6a into the surface 4i of the antenna support body 4.

In some special illustrative examples herein, the antenna-wiring pattern 6a may be formed by silver material deposited on the surface 4i (e.g. blanket deposition and subsequent etching or screen-printing). In some special illustrative examples herein, the antenna-wiring pattern 6a may have features with a feature thickness of 1 μm to about 1000 μm's. In some alternative examples, the antenna-wiring pattern 6a may be formed by gold material, copper material, aluminum material and/or an alloy thereof.

Referring to FIG. 2, an ultra-high frequency (UHF) antenna assembly 10 is schematically illustrated, the UHF antenna assembly 10 comprising the UHF antenna device 1 as described above with regard to FIG. 1 and an assembly body 12, e.g., a sleeve body into which the UHF antenna device 1 is at least partially embedded. For example, the UHF antenna loop 6 of the UHF antenna device 1 may be at least partially embedded into the sleeve body 12 by in-molding or attaching the ring of the antenna device 1 on the sleeve body 12 by inserting the sleeve body 12 into the ring of the antenna device 1. According to the illustration in FIG. 2, the surface 40 of the UHF antenna device 1 is exposed at a lateral surface of the sleeve body 12. However, this does not pose any limitation on the present disclosure and the antenna device 1 may be completely embedded into the sleeve body 12 such that no part of the UHF antenna device 1 is exposed in the sleeve body 12, e.g., by in-molding. In other illustrative embodiments of the present disclosure, the antenna wiring pattern 6a and the second loop portion 6b may be at least partially embedded into the sleeve body 12.

Referring to FIG. 2, the UHF antenna assembly 10 may provide the advantage that a configuration of the outer lateral surface of the sleeve body 12 does not affect the UHF antenna loop 6 of the UHF antenna device 1, in particular, the surface area of the outer lateral surface of the sleeve body 12 does not constrain an area covered by the UHF antenna loop 6 of the UHF antenna device 1.

In some illustrative embodiments and as illustrated in FIG. 2, the UHF antenna device 1 may be exposed at an outer surface of the sleeve body 12. However, this does not impose any limitation and the UHF antenna device 1 may be integrated into the sleeve body 12 such that the outer surface of the sleeve body 12 may be a smooth surface, i.e., without any step or projection pattern caused by the UHF antenna device 1. Accordingly, damaging of the UHF antenna device 1 may be avoided when completely accommodating the UHF antenna device 1 into the sleeve body 12.

Referring to FIGS. 3a to 3c, different implementations of the second loop portion 6b in FIG. 1 are schematically shown as equivalent second loop portions, which could substitute the slotted ring shown in FIG. 1 without limitation. In particular, FIG. 3a shows the second loop portion as a slotted ring element with flat cross section, FIG. 3b shows the second loop portion as a slotted ring with round cross section and FIG. 3c shows the slotted second loop portion with quadrangular cross section. However, this is only for mere illustration purposes and the person skilled in the art will appreciate that a round second loop portion, as illustrated with respect to FIGS. 1 to 3, is not limiting to the present disclosure and a polygonal second loop portion with slit may be considered instead, optionally with one or more rounded corners. For example, any of the second loop portions shown in FIGS. 3a to 3c may be substituted by a deformed replacement loop portion obtained by deforming each of the loop portions shown in FIGS. 3a to 3c. A deformation includes an arbitrary bending of the loop portions, including a bending to form a corner or polygonal shape or an oval shape of at least a portion of the illustrated loops. Basically, the second loop portion is designed to supplement a wiring pattern provided in a surface of an antenna support body of arbitrary shape to a complete UHF loop in a manner that a part of the second loop portion used for completing the antenna wiring pattern into a complete UHF loop extends out of the surface of the antenna support body such that the part extending out of the surface of the antenna support body is not in direct contact with the surface of the antenna support body. In other words, the UHF loop receives a spatial 3-dimensional extension that overcomes a confinement of the wiring pattern to a planar pattern provided on the surface of the antenna support body.

After a complete reading of the present disclosure, the person skilled in the art will appreciate that the antenna loop 6 of the UHF antenna device 1 as described above with respect to FIGS. 1 and 2 may be designed to implement a specific resonance frequency. Accordingly, the UHF antenna device 1 may be provided so as to emit and/or receive electromagnetic radiation with a desired specific resonance frequency. For example, the resonance frequency may be defined by a particular design of the first loop portion 6a and the second loop portion 6b. For example, a tuning of the resonance frequency may be achieved upon defining the second loop portion 6b in a specific design (e.g., by implementing the second loop portion 6b regarding at least one of its shapes (e.g., in a manner as described above with respect to FIGS. 3a to 3c), diameter, material and size).

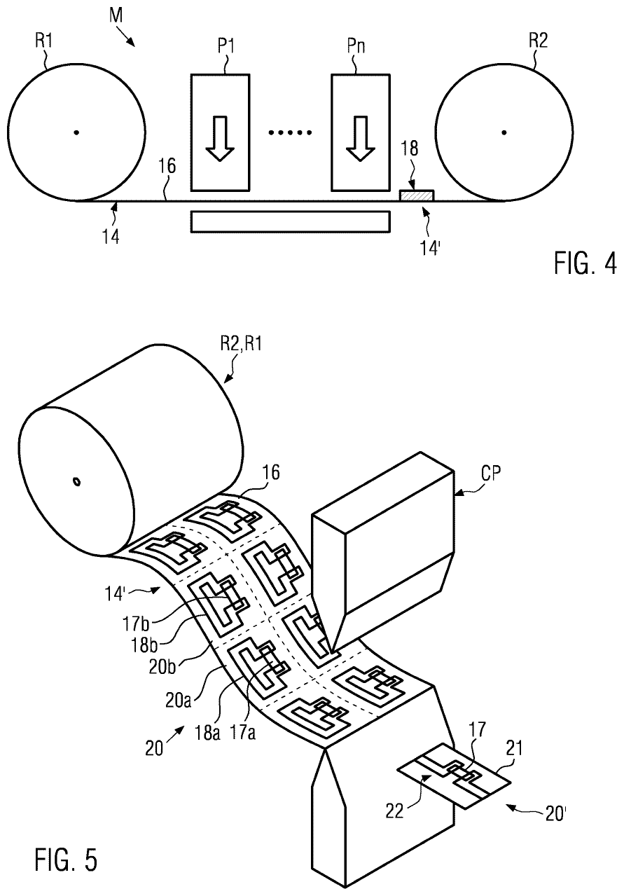

Referring to FIG. 4, fabrication of UHF antenna devices (e.g., the UHF antenna device 1 as described above with respect to FIG. 1) or UHF antenna assemblies (e.g., the UHF antenna assembly 10 as described above with respect to FIG. 2) will be described in accordance with some illustrative embodiments of the present disclosure.

FIG. 4 schematically shows a support body material supply R1 for feeding support body material 14 to a fabrication machine M configured to perform at least one of a sequence of processes as indicated schematically by processes P1 to Pn. That is, only a single process P1 or a sequence of processes P1, P2 or P1, P2, P3 or P1, P2, P3 . . . . Pn where n is a natural number greater three (n≥3), may be performed to process the support body material 14 supplied by the support body material supply R1. In some illustrative embodiments and as schematically illustrated in FIG. 4, the support body material supply R1 may be a reel on which the support body material 14 is wound. This illustrate example is employed in accordance with embodiments where the support body material 14 is a foil, a flexible sheet or a flexible PCB material. However, this does not pose any limitation to the present disclosure, and in case of a rigid and non-deformable support body material, the support body material may be supplied from an appropriate support body material supply for storing and supplying rigid material to the fabrication machine M. Although the fabrication machine M is referred to as a machine in singular, this does not pose any limitation of the present disclosure and the person skilled in the art will appreciate that it may comprise a plurality of machines that are coupled together or separated and distributed at different locations such that different processes may be performed at different times at different fabrication sites.

Referring to FIG. 4, a reel-to-reel process is schematically illustrated where a support body material supply R1 supplies or feeds support body material 14 to the fabrication machine M which performs one or more fabrication processes P1, . . . , Pn to the support body material 14, e.g. forming an antenna-wiring pattern 18 on a surface 16 of the support body material 14, the processed support body material 14′ at the exit of the machine M after the processes P1, . . . , Pn being completed, being fed or supplied to a reel R2 representing support body material supply at a more advanced stage during fabrication.

In accordance with some illustrative embodiments of the present disclosure, the support body material supply R1 may feed the support body material 14 to the fabrication machine M performing a process P1 of forming a repetitive pattern of an antenna-wiring loop on a surface, i.e., the surface 16 of the support body material 14, when the support body material 14 at the process P1 being terminated having a plurality of antenna fields, not illustrated, formed on the surface 16, each of which being provided with an antenna wiring loop (not illustrated in FIG. 4). Accordingly, in case that only the process P1 is performed (P1, . . . , Pn=P1), the support body material 14′ supplied to the reel R2 has a repetitive pattern of antenna working loops formed thereon as represented by reference numeral 18 in FIG. 4 in this respect. In some illustrative examples herein, a subsequent process P2 (Pn, n=2) may be performed subsequent to process P1, wherein a RFID chip is arranged in each antenna field region of the support body material 14′.

In accordance with some illustrative embodiments of the present disclosure, the process P1 may correspond to a screen-printing process in which conductive material for forming the antenna-wiring loop is printed onto the surface 16 of the support body material 14. Alternatively, the process P1 may comprise a sequence of sub-processes, comprising a blanket deposition of a conductive material layer on the surface 16 of the support body material 14, followed by an etching process for pattering the blanket deposited conductive material into the repetitive pattern of antenna wiring loops across the plurality of antenna field regions on the surface 16 of the support body material 14.

Referring to FIG. 5, a stage during processing of the support body material is schematically shown. The stage illustrated in FIG. 5 may either be subsequent to the fabrication process described above with regard to FIG. 4 (in this case the reel R2 is used as a support body material supply for the stage shown in FIG. 5), or the stage shown in FIG. 5 represents a final process of the sequence of processes P1, . . . , Pn at the end of the machine M in FIG. 4 (in which case the reel R1 as indicated in FIG. 5 as the support body material supply, while the process in FIG. 4 does not have a reel-to-reel process configuration and R2 is omitted in this case).

As illustrated in FIG. 5, the stage shown in FIG. 5 is a cutting/punching stage CP in which support body material 14′ is supplied by the support body material supple R1, R2 in FIG. 5 and feed to a cutting/punching process stage CP for separating the support body material 14′ into a plurality of separated antenna field regions 21.

Referring to FIG. 5, the support body material 14′ as supplied by the support body material supply R1, R2 has a repetitive pattern 20 of antenna wiring loops 20a, 20b formed thereon. The antenna-wiring loops 18a, 18b provided in each antenna field region 20a, 20b of plurality of the antenna field regions 20 may be equipped with an RFID chip 17a, 17b such that the antenna-wiring loops represent functional loops at the stage shown in FIG. 5 prior to the cutting/punching process CP. That is, the surface 16 of the support body material 14′ is equipped with functional antenna-wiring loops, which may be subjected to a testing prior to the cutting/punching process CP in FIG. 5. In this regard, one of the processes in P1, . . . , Pn subsequent to the formation of the functional antenna-wiring loops in each of the antenna field regions 20 may comprise a UHF reading device for subjecting the plurality of antenna field regions 20 to a test reading. On the basis of the test reading, it is possible to identify malfunctioning antenna-wiring loops in the support body material supply R1, R2 either at the end of the reel-to-reel process shown in FIG. 4 or during the reel-to-reel process shown in FIG. 4.

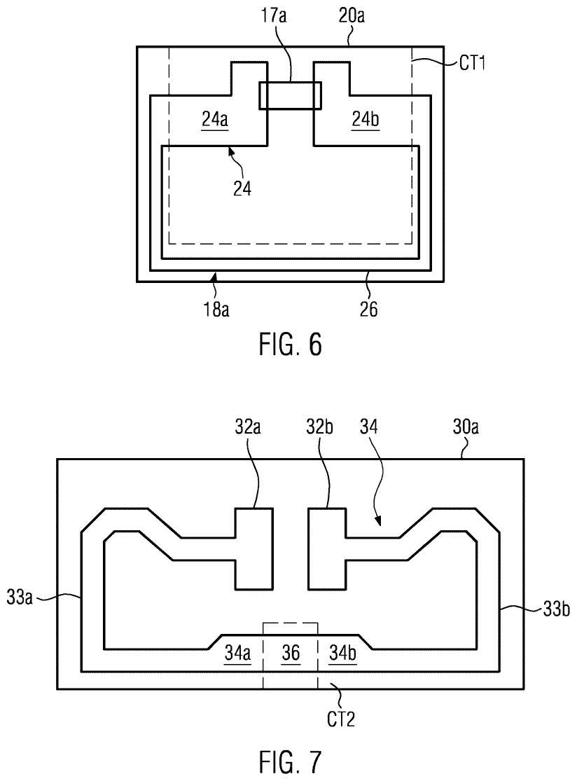

With regard to FIGS. 6 and 7, the punching process CP will be described in greater detail. It is emphasized at this point, that, although FIGS. 5 to 7 explicitly illustrate specific antenna-wiring loop patterns, the illustration of a specific antenna-wiring loop pattern is only for the purpose of illustration and not indented for limiting the scope of the disclosure. It is solely intended to provide a clear teaching of the idea of preparing testable antenna-wiring loops during the fabrication of support body material supplies which may then be further processed to result in support body materials that can form the basis for the further fabrication of antenna support bodies (see antenna support body 4 in FIGS. 1 and 2) when fabricating UHF antenna devices (see antenna device 1 as described above with regard to FIGS. 1 to 3).

Referring to FIG. 6, an antenna field portion 20a corresponding to an enlarged view of the antenna field region 20a in FIG. 5 is schematically illustrated in a top view. The antenna field region 20a comprises an antenna wiring loop 18a formed on the surface 16 of the support body material 14′ in FIG. 5 in form of an antenna wiring pattern. The antenna wiring loop 18a is electrically coupled with an RFID chip 17a forming a bridging portion between two contact pads 24a and 24b. Accordingly, the antenna-wiring loop 18a is fully functional and may be tested by exposing the antenna-wiring loop 18a to an UHF test reader (not illustrated). Upon appropriately defining the antenna-wiring loop 18a on the basis of designing any of its parts with respect to shape and/or width and/or material and/or size, a specific resonance frequency of the antenna wiring loop 18a is defined and/or tuned.

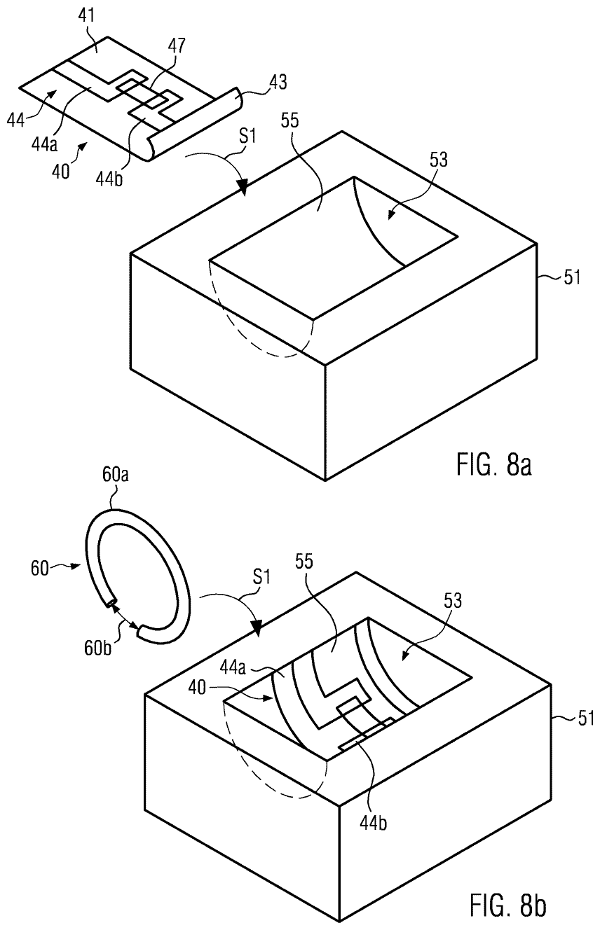

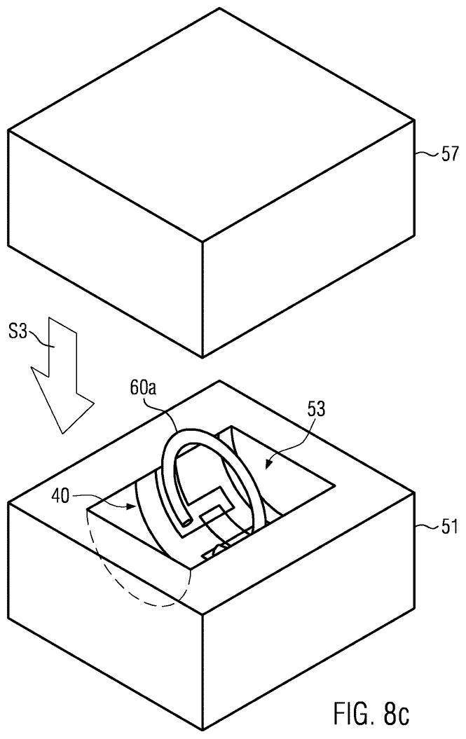

When subjecting the support body material 14′ in FIG. 5 to the cut/punch process CP in FIG. 5, a punching of the antenna field region 20a takes place as indicated by the broken line CT1 in FIG. 6. According to the cutting line CT1 in FIG. 6, the cutting/punching process CP cuts/punches a part of the antenna field region 20a away such that a portion 26 connecting the contact pads 24a and 24b to form a loop away, such that the contact pads 24a and 24b are only coupled by the bridging portion 17a, i.e. the RFID chip 17a. Accordingly, a partial antenna-wiring loop 24 remains after the cutting/punching process CP, the partial antenna-wiring loop comprising the two contact pads 24a, 24b and the RFID chip 17a. The accordingly obtained partial wiring loop 24 may then be supplemented to an UHF antenna loop (not illustrated) in accordance with a second loop portion (not illustrated) as described with respect to FIGS. 1 to 3 by means of the second loop portion 6b above. However, at the stage shown in FIG. 5 by means of the antenna field region 20′ after the cutting/punching process CP was performed, the resulting partial antenna-wiring loop 22 in FIG. 5 is not a complete UHF antenna loop at this stage during fabrication. Accordingly, the antenna field region after the cutting/punching process CP in FIG. 5 is performed, represents an antenna support body 21 that can be subjected to further processing as described below with regard to FIGS. 8a to 8c.

Referring to FIG. 7, an alternative embodiment for the antenna-wiring pattern is described in greater detail.

Referring to FIG. 7, an antenna field portion 30a in an alternative but not-limiting embodiment is schematically illustrated in a top view. In the illustrative example of FIG. 7, the antenna field portion 30a may be implemented instead of the antenna field region 20a as shown in FIG. 5 when applying the process described with respect to FIG. 5. Accordingly, the disclosure above as presented with respect to FIG. 5 applies accordingly to FIG. 7.

The antenna field region 30a comprises an antenna-wiring pattern 34, which may be accordingly formed as an antenna-wiring loop on the surface 16 of the support body material 14′ in FIG. 5. The antenna-wiring pattern 34 may be electrically coupled with an RFID chip (not illustrated, corresponding to the RFID chip 17a of FIGS. 5 and 6) providing bridging portions 33a, 33b between two respective ones of contact pads 32a, 32b and contact pad regions 34a, 34b of the antenna-wiring pattern 34. For example, the contact pad regions 34a and 34b may be provided in integral form with a test region 36 such that the contact pad regions 34a, 34b and the test region 36 are implemented as a strip portion of increased width when compared to the bridging portions 33a, 33b. In other words, the antenna-wiring pattern 34 is provided in form of an antenna-wiring loop by the test region 36 coupling the contact pad regions 34a and 34b with each other and by an RFID chip (not illustrated) coupled to the contact pads 32a, 32b. In this way, the antenna-wiring pattern 34 may offer the possibility for a test structure used for testing the antenna-wiring pattern 34 by exposing the accordingly provided antenna-wiring loop to an UHF test reader (not illustrated).

Although the bridging portions 33a and 33b of the antenna-wiring pattern 34 are illustrated as C-shaped wiring track patterns formed on a surface of the antenna field region 30a, this does not pose any limitation on the present disclosure and any other shape and configuration for electrically coupling the contact pads 32a and 32b with contact pad regions 34a and 34b may be employed. For example, the bridging portions 33a and 33b may be of a quadrangular shape or a polygonal shape or may comprise wiring track sections formed on different surfaces of the antenna field region 30a, the wiring track section connected by structures of vertical interconnect access (VIA) elements formed in the antenna field region 30a. Upon appropriately defining the antenna-wiring pattern 34 on the basis of designing any of its parts 33a and 33b with respect to shape and/or width and/or material and/or size, a specific resonance frequency of the antenna wiring pattern 34 is defined and/or tuned.

When subjecting the support body material 14′ in FIG. 5 to the cut/punch process CP in FIG. 5, a punching of the antenna field region 30a takes place as indicated by the broken line CT2 in FIG. 7. According to the cutting line CT2 in FIG. 7, the cutting/punching process CP cuts/punches a part of the antenna field region 30a away such that the test portion 36 connecting the contact pad regions 34a and 34b such that the connected contact pad regions 34a and 34b form contact pads remain in the antenna field region 30a after the punching/cutting of the region 36 away. After the punching/cutting as indicated by broken lines CT2 in FIG. 7, the antenna-wiring pattern 34 provides a partial antenna-wiring loop, which remains after the cutting/punching process. The accordingly formed partial antenna-wiring loop (which may then be designated by reference numeral 34 now referring to the partial antenna-wiring loop after removal of the test region 36 enclosed by the cutting lines CT2) now comprises the two contact pads 34a, 34b in addition to the contact pads 32a and 32b.

The accordingly obtained partial wiring loop 34 may then be supplemented to an UHF antenna loop (not illustrated) in accordance with a second loop portion (not illustrated) as described with respect to FIGS. 1 to 3 by means of the second loop portion 6b above. However, at the stage shown in FIG. 5 in combination with FIG. 7 by means of the antenna field region 30a in FIG. 7 after the cutting/punching process CP was performed, the resulting partial antenna-wiring loop 34 in FIG. 7 is not a complete UHF antenna loop at this stage during fabrication. Accordingly, the antenna field region after the cutting/punching process CP in FIG. 7 is performed represents an antenna support body that can be subjected to further processing as described below with regard to FIGS. 8a to 8c.

Although FIG. 5 shows only one form of antenna-wiring pattern formed in the plurality of antenna field regions 20, this does not imply any limitation and the antenna field regions 20 may comprise different subsets of antenna field regions having different configurations of antenna-wiring patterns formed therein. Accordingly, the support body material supply R1, R2 may be provided with mixed antenna-wiring patterns for providing different UHF antenna loop configurations on the same support body material supply R1, R2.

Referring to FIGS. 8a to 8c, further stages during the fabrication of a UHF antenna device in accordance with some illustrative embodiments of the present disclosure will be described. FIG. 8a shows an initial stage during the fabrication of an UHF antenna assembly, e.g. the UHF antenna assembly 10 in FIG. 2, will be described. FIG. 8a shows an antenna support body 40 having a radio frequency identification (RFID) chip 47 attached to an antenna-wiring pattern 44 provided on a surface 41 of the antenna support body 40.

In an initial process step S1, the antenna support body 40 with the RFID chip 47 is inserted into a cavity 53 of a mold 51 such that the surface 41 of the antenna support body 40 is exposed within the cavity 53, while an opposite surface 43 of the antenna support body 40 faces a surface 55 of the cavity 53. In the illustration of FIG. 8a, a semi-cylindrical cavity 53 is illustrated. However, this does not pose any limitation on the present disclosure and any other appropriate shape of the cavity 53 may be realized instead. For example, the cavity 53 may have tapering or conical or spherical or polygonal surfaces.

Referring to FIG. 8b, a subsequent step during fabrication of a UHF antenna assembly is illustrated, the subsequent step S2 comprising inserting a second loop portion 60 into the cavity 53 of the mold 51 such that the second loop portion 60 complements the antenna-wiring pattern 44 formed on the surface 41 of the antenna support body 40 into a UHF antenna loop. As illustrated in FIG. 8b the second loop portion 60 may be a slotted ring, e.g. a sur-clip, such that the second loop portion 60 comprises a ring portion 60a and a slit 60b extending across a circumferential region of the ring body 60a (the circumferential region of the slit 60b is indicated by double arrows in the illustration of FIG. 8b).

Referring to FIG. 8c, a subsequent stage during fabrication schematically shown in which the second loop portion 60 is inserted into the cavity 53 of the mold 51. In particular, the second loop portion 60 is inserted in that the slit 60b faces towards the antenna-wiring pattern 44 of the antenna support body 40. Herein, the ring body 60a of the second loop portion 60 may be fitted into the cavity 53 by clamping the ring body 60a into the cavity using the mechanical spring characteristic of the ring body 60a. In this way, it is possible to avoid a bonding or welding process such that the antenna-wiring pattern 44 is not exposed to harsh chemical or warming environments and the integrity of the antenna-wiring pattern may be preserved. Furthermore, it is possible to reduce a thermal load on the material of the antenna support body 40 in that no separate bonding process is applied when inserting the second loop portion 60 into the cavity 53.

Subsequently, in a process step S3, the mold tool 51 may be closed by an upper mold part 57, thereby complementing the cavity 53 to a molding cavity provided by the mold tools 51 and 57. Subsequently, an in-molding process may be performed by injecting a mold material into the molding tool. Upon curing the injected molding material, the second loop portion 60 is maintained in electrical connection with the antenna-wiring pattern 44 of the antenna support body 40.

Although FIGS. 8a to 8c show an in-mold process with a cavity 53 formed in the mold 51 of the shape of a half-shell. The person skilled in the art will appreciate that the specific shape of the cavity 53 and the illustrated configuration of the mold 51 is only for illustrative purposes and not intended for limiting the present disclosure to a particular configuration of the mold and the molding process. Instead, any appropriate shape and configuration of a molding tool and its molding cavity is possible without deviating from the present disclosure. For example, the cavity 53 in the mold 51 may be provided in form of a cylindrical bore extending into the mold 51 instead of the illustrated half-shell form of the cavity 53. For example, in case of a cavity being formed as a full cylindrical bore, the support body 40 being rolled and inserted into the cylindrical bore and the second loop portion 60 may be inserted into the bore. The second loop portion 60 being a slotted ring, e.g., a circlip, the ring may be inserted into the cylindrical bore by elastically deforming, e.g., squeezing, the ring to a smaller diameter which allows inserting the ring into the cylindrical bore, and releasing the inserted ring when appropriately inserted within the cavity. An elastic deformation of the ring is possible due to the slotted configuration, and no additional bonding of the ring to the support body 40 within the cavity is necessary. In general, any shape of the cavity is possible as long as the second loop portion 60 is matched with the cavity, such as any of the configuration of the second loop portion as described above with respect to FIGS. 3a to 3c, the disclosure of which being incorporated at this point by reference in its entirety.

Referring to the embodiments as described above with respect to FIGS. 1 to 8, an antenna support body may be formed of a thermoplastic material. In accordance with illustrative examples, the accordingly formed antenna support body may be formed of polyolefin such as polypropylene (PP), polyethylene (PE) and the like. Herein, PP is a material which may be subjected to disinfectants for disinfecting the antenna support body or and UHF antenna assembly comprising such an antenna support body.

Furthermore, after taking the above disclosure into account, the person skilled in the art will appreciate that, upon appropriately selecting the material of the antenna support body, the antenna support body may be provided in compliance with the material of an item to be labelled with the UHF antenna device. For example, when applying the UHF antenna device for labelling an in-mold product, a material of the antenna support body may be chosen to be equal to or match best the material of the in-mold product. Accordingly, the antenna support body may be integrated into the in-mold process without deteriorating the integrity of the mold product. For example, when using a similar or equal material to the in-mold material used in in-molding the antenna device, formation of bubbles and/or the flaking off of the antenna support body of an item to be labelled is avoided.

In some illustrative but non-limiting examples of an UHF antenna device and/or UHF antenna assembly as described above, the accordingly described UHF antenna device and/or UHF antenna assembly may be a cap element or sleeve, such as a cap or sleeve employed in medical applications.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” or “substantially” as applied to a particular value of a range applies to both values, and unless otherwise dependent on the precision of the instrument measuring the value, may indicate +/−10% of the stated value(s).

1. An ultra-high frequency (UHF) antenna device, comprising:
a radio-frequency identification (RFID) chip;
an antenna support body with an antenna-wiring pattern formed on a surface of the antenna support body; and
an UHF antenna loop electrically coupling to the RFID chip, wherein the UHF antenna loop is configured to emit and/or receive a frequency range in the UHF band,
wherein the UHF antenna loop comprises a first loop portion formed of the antenna-wiring pattern and a second loop portion extending at least partially outside of the antenna support body.

2. The UHF antenna device of claim 1, wherein:
the antenna support body is formed of a support body of slotted shape with an outer lateral surface and an inner surface radially opposite to the outer lateral surface, the outer lateral surface and the inner surface being discontinued by a slit which axially extends along the support body;
the support body has at least two contact pads formed on the inner surface and separated by a gap extending over a gap region between the two contact pads; and
the antenna-wiring pattern comprises a bridging portion formed on the inner surface for electrically coupling at least two of the at least two contact pads on the support body along a first circumferential region along the inner surface, the bridging portion being electrically coupled with the RFID chip.

3. The UHF antenna device of claim 2, wherein the RFID chip is located within the first circumferential region.

4. The UHF antenna device of claim 2, wherein the second loop portion comprises a slotted ring in electrical connection with the at least two contact pads which are in electrical connection with the RFID chip.

5. The UHF antenna device of claim 4, wherein the slotted ring has a slit formed therein, the slit axially extending along the inner surface in a second circumferential region, and wherein the second circumferential region and at least one of the first circumferential region and the gap region are arranged so as to at least partially overlap.

6. The UHF antenna device of claim 1, wherein the antenna support body is formed of a support sheet rolled into a cylindrical or semi-cylindrical shape.

7.-8. (canceled)

9. An ultra-high frequency (UHF) antenna assembly, comprising the UHF antenna device of claim 1, and an assembly body, wherein the UHF antenna device is integrated into the assembly body.

10. A method of forming an ultra-high frequency (UHF) antenna device, the method comprising:
providing a support body material supply for feeding support body material;
forming a repetitive pattern of an antenna-wiring loop on a surface of the support body material supplied by the support body material supply, wherein the support body material has a plurality of antenna field regions, each of which being provided with an antenna-wiring loop;
removing at least one of the plurality of antenna field regions formed on a surface of the support body material from the support body material supply;
preparing an antenna support body on the basis of at least one removed antenna field region, wherein a partial antenna-wiring loop defining a first loop portion as an antenna-wiring pattern is formed in each removed antenna field region; and
complementing the partial antenna-wiring loop into a complete UHF antenna loop by electrically coupling a second loop portion to the first loop portion, wherein the second loop portion extends at least partially outside of the antenna support body,
wherein the partial antenna-wiring loop is obtained during or after removing the at least one antenna field region from the support body material supply when a wiring loop portion of the antenna-wiring loop is removed.

11. The method of claim 10, wherein the partial antenna-wiring loop in each antenna field region comprises at least two contact pads, and wherein forming the repetitive pattern of the antenna-wiring loop comprises electrically coupling the antenna-wiring loop of at least one antenna field region with a radio-frequency identification (RFID) chip prior to removing the wiring loop portion.

12. The method of claim 11, wherein preparing the antenna support body comprises rolling the removed at least one antenna field region into a cylindrical or semi-cylindrical shape.

13. The method of claim 11, further comprising performing a test on at least one antenna field region coupled with the RFID chip by exposing the at least one antenna field region coupled with the RFID chip to an UHF reader device prior to the preparing of the antenna support body.

14. The method of one of claim 10, wherein forming the repetitive pattern of the antenna-wiring loop comprises depositing a conductive material layer on the surface of the support body material by screen printing conductive material onto the surface of the support body material.

15. The method of claim 10, wherein forming the repetitive pattern of the antenna-wiring loop comprises depositing a conductive material layer on a surface of the support body material and patterning the deposited conductive material layer by applying an etching process.

16. The method of claim 10, wherein removing at least one of the plurality of antenna field regions comprising applying one or more punching processes for separating at least one of the antenna field regions from the support body material supply.

17. The method of claim 10, wherein complementing the partial antenna-wiring loop into a complete UHF antenna loop comprises:
inserting a separated antenna field region into a mold cavity of a mold tool such that the partial antenna-wiring loop is exposed to the interior of the mold cavity; and
inserting a slotted ring into the mold cavity such that the slotted ring is brought into mechanical contact with the partial antenna-wiring loop so as to complete the partial antenna-wiring loop into the complete UHF antenna loop, a slit of the slotted ring being arranged in contact with the antenna field region; and
injecting molding material into the cavity of the mold tool.

18. A method of fabricating an ultra-high frequency (UHF) antenna device, the method comprising:
providing a support body material supply for feeding support body material;
forming a repetitive pattern of at least two contact pads on a plurality of antenna field regions of the support body material, each antenna field region of the plurality of antenna field regions comprising the repetitive pattern of at least two contact pads;
forming a bridging portion in each antenna field region for electrically coupling at least two of the at least two contact pads, the bridging portion comprising a radio-frequency identification (RFID) chip electrically coupling the at least two of the at least two contact pads with each other; and
forming a repetitive test structure pattern with at least one test track on the support body material for supplementing the at least two contact pads coupled with the RFID chip into an UHF loop structure in each antenna field region.

19. The method of claim 18, wherein forming the repetitive pattern of at least two contact pads and/or forming the repetitive test structure pattern comprises depositing a conductive material layer on a surface of the support body material by screen printing conductive material onto the surface of the support body material.

20. The method of claim 18, wherein forming the repetitive pattern of at least two contact pads and/or forming the repetitive test structure pattern comprises depositing a conductive material layer on a surface of the support body material and patterning the deposited conductive material layer by applying an etching process.

21. The method of one of claim 18, further comprising applying one or more punching processes for separating the antenna field regions from the support body material supply and removing the test structure pattern in each antenna field region.

22. The method of claim 21, further comprising:
inserting separated antenna field regions into each mold cavity of a mold tool such that the contact pads of each antenna field region are exposed to the interior of the respective mold cavity of the mold tool;
inserting a slotted ring into each mold cavity of the mold tool equipped with a respective separated antenna field region such that the slotted ring in a respective mold cavity is brought into mechanical contact with the at least two of the at least two contact pads coupled by the bridging portion, a slit of the slotted ring being arranged at the bridging portion in the respective mold cavity; and
injecting molding material into each cavity of the mold tool.

23.-25. (canceled)

26. A support body material supply, comprising:
a reel of support body material wound on the reel;
a repetitive pattern of an antenna-wiring loop formed on a surface of the support body material supplied by the support body material supply, wherein the support body material has a plurality of antenna field regions, each of which being provided with an antenna-wiring loop; and
a plurality of radio-frequency identification (RFID) chips, each of which being electrically coupled with the antenna-wiring loop of each antenna field region,
wherein the repetitive pattern of antenna-wiring loops is formed of a repetitive pattern of at least two contact pads on the plurality of antenna field regions of the support body material, each antenna field region of the plurality of antenna field regions comprising the repetitive pattern of at least two contact pads, a bridging portion formed in each antenna field region for electrically coupling at least two of the at least two contact pads, the bridging portion comprising an RFID chip of the plurality of RFID chips electrically coupling the at least two of the at least two contact pads with each other, and a repetitive test structure pattern formed with at least one test track on the support body material for supplementing the at least two contact pads coupled with the RFID chip into an UHF loop structure in each antenna field region.

27.-30. (canceled)
